(19) United States
(12) Patent Application Publication
(10) Pub. No.: US 2021/0263616 A1
(43) Pub. Date: Aug. 26, 2021

(54) TOUCH PANEL, TOUCH DISPLAY SCREEN, AND TERMINAL

(71) Applicant: Shenzhen Royole Technologies Co., Ltd., Shenzhen (CN)

(72) Inventors: Yanan Zhang, Shenzhen (CN); Donglin Li, Shenzhen (CN); Weisheng Su, Shenzhen (CN); Yuancheng Lin, Shenzhen (CN)

(21) Appl. No.: 17/318,008

(22) Filed: May 12, 2021

Related U.S. Application Data
(63) Continuation of application No. PCT/CN2018/115072, filed on Nov. 12, 2018.

(51) Int. Cl. G06F 3/044

(52) U.S. Cl. CPC G06F 3/0445; G06F 3/0446

(57) ABSTRACT

A touch panel, a touch display screen and a terminal are provided. The touch panel includes a touch unit. The touch unit includes an insulating layer, a first electrode disposed on one side of the insulating layer, and a second electrode disposed on the other side of the insulating layer. Orthographic projections of the first electrode and the second electrode on the insulating layer form an overlapped area. The first electrode includes a first section corresponding to the overlapped area, and the second electrode includes a second section corresponding to the overlapped area. At least one of an extending direction of the first section and an extending direction of the second section is inclined with respect to an outer edge of the touch panel.

### CROSS-REFERENCE TO RELATED APPLICATIONS

This application is a continuation application of International (PCT) Patent Application No. PCT/CN2018/115072, filed on Nov. 12, 2018, and entitled “touch panel, touch display screen, and terminal,” the entire contents of which are incorporated herein by reference.

### TECHNICAL FIELD

The present disclosure relates to the field of touch technologies, and in particular, relates to a touch panel, a touch display screen, and a terminal.

### BACKGROUND

Generally, a touch panel of a touch display screen includes transmitting electrodes and receiving electrodes that are overlapped with each other and form overlapped areas. The transmitting electrodes and the receiving electrodes are disposed on different surfaces of the touch panel, and edges of the overlapped regions are perpendicular to or parallel to an outer edge of the touch panel. When the touch display screen emits lights, human eyes are sensitive to horizontal or vertical construction of the overlapped area, and may easily see etching textures or grids on the electrode, which affects use of the touch panel.

### SUMMARY

A touch panel according to an embodiment of the present disclosure includes a touch unit. The touch unit includes an insulating layer, a first electrode disposed on one side of the insulating layer, and a second electrode disposed on the other side of the insulating layer. Orthographic projections of the first electrode and the second electrode on the insulating layer form an overlapped area. The first electrode includes a first section corresponding to the overlapped area, and the second electrode includes a second section corresponding to the overlapped area. An extending direction of the first section and/or an extending direction of the second section is inclined with respect to an outer edge of the touch panel.

A touch display screen according to an embodiment of the present disclosure includes a display panel, and the touch panel as described above. The touch panel and the display panel are laminated.

A terminal according to an embodiment of the present disclosure includes a housing, and the touch display screen as described above. The touch display screen is arranged in the housing.

### BRIEF DESCRIPTION OF THE DRAWINGS

The above described and/or additional aspects and advantages of the present disclosure would be obvious and simple to understand with reference to the description of the embodiments in combination with the accompanying drawings.

FIG. 1 is a schematic planar diagram of a terminal according to an embodiment of the present disclosure.

FIG. 2 is a schematic planar diagram of a touch display screen according to an embodiment of the present disclosure.

FIG. 3 is a schematic section view, taken along an direction, of the touch display screen as illustrated in FIG. 2.

FIG. 4 is a schematic enlarged diagram of a partial structure of a touch panel according to an embodiment of the present disclosure.

FIG. 5 is a schematic planar diagram of a touch unit formed by a first electrode and a second electrode according to an embodiment of the present disclosure.

FIG. 6 is a schematic planar diagram of a touch panel formed by a plurality of touch units according to the embodiment illustrated in FIG. 5.

FIG. 7 is a schematic planar diagram of a touch unit formed by a first electrode and a second electrode according to another embodiment of the present disclosure.

FIG. 8 is a schematic planar diagram of a touch panel formed by a plurality of touch units according to the embodiment illustrated in FIG. 7.

FIG. 9 is a schematic planar diagram of a touch unit formed by a first electrode and a second electrode according to still another embodiment of the present disclosure.

FIG. 10 is a schematic planar diagram of a touch unit formed by a first electrode and a second electrode according to yet still another embodiment of the present disclosure.

FIG. 11 is a schematic planar diagram of a touch panel formed by a plurality of touch units according to the embodiment illustrated in FIG. 10.

FIG. 12 is a schematic planar diagram of a first electrode and a second electrode according to yet still another embodiment of the present disclosure.

Main reference numerals and denotations thereof: 10—touch display screen, 12—touch panel, 122—touch unit, 1222—insulating layer, 1224—first electrode, 122a—first section, 122c—first sub-section, 1226—second electrode, 122b—second section, 124—overlapped area, 126—first edge, 128—second edge, 14—display panel, 142—third edge, 144—fourth edge, 20—housing, 100—terminal.

### DETAILED DESCRIPTION

The embodiments of the present disclosure are described in detail hereinafter. Examples of the described embodiments are given in the accompanying drawings, wherein the identical or similar reference numerals constantly denote the identical or similar elements or elements having the identical or similar functions. The specific embodiments described with reference to the attached drawings are all exemplary, and are intended to illustrate and interpret the present disclosure, which shall not be construed as causing limitations to the present disclosure.

In the description of some embodiments of the present disclosure, it should be understood that the terms “central,” “transversal,” “longitudinal,” “length,” “width,” “thickness,” “upper,” “lower,” “front,”, “rear,” “left,” “right,” “vertical,” “horizontal,” “top,” “bottom,” “inner,” “outer,” “clockwise,” “counterclockwise,” “axial,” “radial,” “circumferential,” and the like indicate orientations and position relationships which are based on the illustrations in the accompanying drawings, and these terms are merely for ease and brevity of the present disclosure, instead of indicating or implying that the devices or elements shall have a particular orientation and shall be structured and operated based on the particular orientation. Accordingly, these terms shall not be construed as limiting the present disclosure. In addition, terms of “first” and “second” are only used for description, but shall not be understood as indication or implication of relative importance or implicit indication of the number of the specific technical features. Therefore, the features defined by the terms “first” and “second” may explicitly or implicitly include one or more of these features. In the description of the present disclosure, the term “multiple” or “a plurality of” signifies at least two, unless otherwise specified.

Disclosure hereinafter provides many different embodiments or examples to practice different structures of the present disclosure. For simplification of the disclosure of the present application, parts and settings in specific examples are described hereinafter. Nevertheless, these examples are only intended to illustrate the present disclosure, instead of limiting the present disclosure. In addition, the reference numerals and/or reference letters may be repeated in different examples in the present disclosure. Such repetitions are intended to achieve simplification and clarity, and do not denote a relationship between the discussed embodiments and/or settings. Further, the present disclosure provides examples of various specific processes and materials. However, persons of ordinary skill in the art would note that other processes and/or other materials are also applicable.

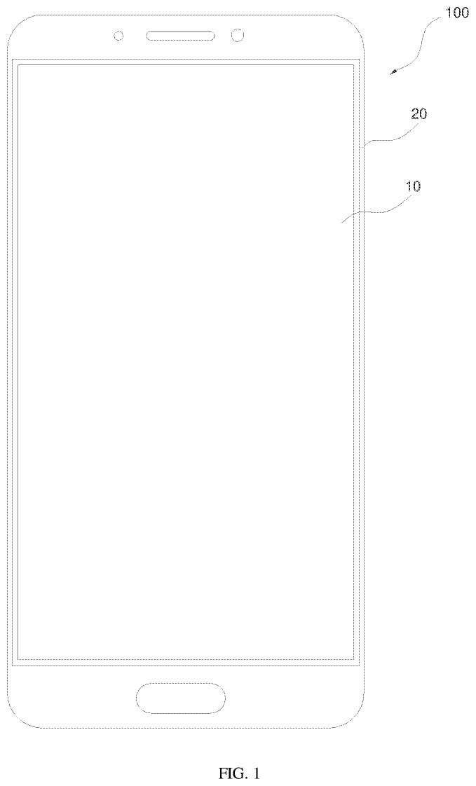

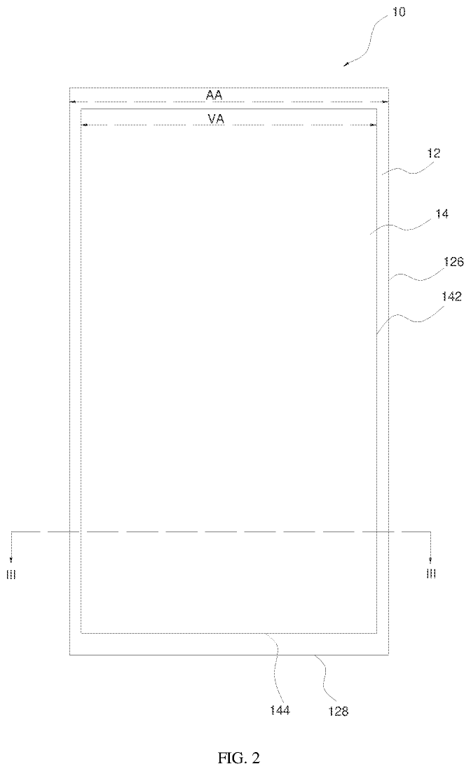

Referring to FIG. 1 and FIG. 2, the present disclosure provides a touch panel 12, a touch display screen 10, and a terminal 100. The touch panel 12 is applicable to the touch display screen 10. The touch display screen 10 is applicable to the terminal 100. The terminal 100 includes, but is not limited to, a mobile phone, a tablet computer, a smart watch, a wearable smart device, or the like. The embodiments of the present disclosure are described by exemplifying the terminal 100 as a mobile phone. Nevertheless, the terminal 100 may also be other devices, which is not limited herein.

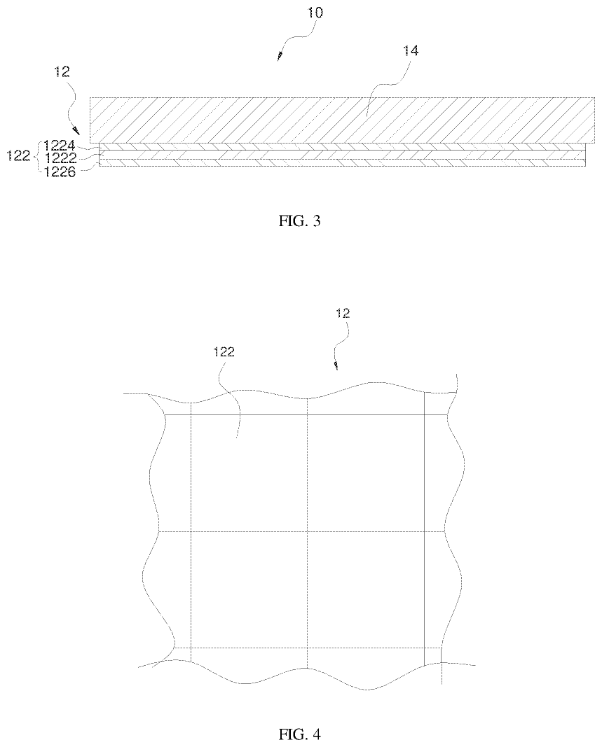

Referring to FIG. 3 to FIG. 5, the touch panel 12 according to embodiments of the present disclosure is applicable to the touch display screen 10. The touch display screen 10 includes a display panel 14. The touch panel 12 and the display panel 14 are laminated. The touch panel 12 includes a touch unit 122. The touch unit 122 includes an insulating layer 1222, a first electrode 1224 disposed on one side of the insulating layer 1222 and a second electrode 1226 disposed on the other side of the insulating layer 1222. Orthographic projections of the first electrode 1224 and the second electrode 1226 on the insulating layer 1222 are intersected to form an overlapped area 124, the first electrode 1224 includes a first section 122a corresponding to the overlapped area 124, and the second electrode 1226 includes a second section 122b corresponding to the overlapped area 124. An extending direction of the first section 122a and/or an extending direction of the second section 122b is inclined with respect to an outer edge of the touch panel 12.

Since human eyes are intrinsically sensitive to shapes and lines, especially shapes and lines with obvious orientation. According to visual features of the human eyes, whether an object is obvious not only depends on the light reflected by the object to the human eyes, but also depends on processing of images by the human eyes according to visual habits. Therefore, if the first section 122a and the second section 122b are parallel or perpendicular with respect to the outer edge of the touch panel 12, it is apparent for a user to observe perpendicular or parallel etching textures or grids on the first electrode 1224 and/or second electrode 1226, such that use of the touch panel 12 is affected.

In the touch panel 12 according to the embodiments of the present disclosure, the extending direction of the first section 122a of the first electrode 1224 is inclined with respect to the outer edge of the touch panel 12, and/or the extending direction of the second section 122b of the second electrode 1226 is inclined with respect to the outer edge of the touch panel 12, and a relative angle (interaction angle) between the first section 122a and the second section 122b affects the extending direction of the first section 122a and the extending direction of the second section 122b. Therefore, by changing the interaction angle between the first section 122a and the second section 122b, inclination degrees of the first section 122a and the second section 122b with respect to the outer edge of the touch panel 12, and hence visual experience of the human eyes may be improved. In this way, an optical effect of the touch panel 12 is improved, a shadow elimination effect of the touch panel 12 is enhanced, visibility of the human eyes to the etching textures or grids on the touch panel 12 is lowered, and quality of the touch display screen 10 and the terminal 100 is ensured.

In addition, since the first electrode 1224 and the second electrode 1226 each form an electric field, the electric fields of these two electrodes are subject to mutual impacts, and a mutual-capacitance coefficient subject to mutual impacts between these two electric field is rapidly decreased with increase of a distance between opposing edges of the first electrode 1224 and the second electrode 1226, the less the distance between the opposing edges (two sides of the two electrodes) of the first electrode 1224 and the second electrode 1226, the greater the lengths of the two opposing edges, the greater the mutual-capacitance between the two electrodes, and the higher the sensitivity of the touch panel 12.

When the first section 122a and the second section 122b are inclined with respect to the outer edge of the touch panel 12, the lengths of the edges of the first section 122a and the second section 122b are also increased, such that an interaction distance and a total interaction length of the two opposing edges of the first electrode 1224 and the second electrode 1226 are increased to some extent.

A fundamental mutual-capacitance between the first electrode 1224 and the second electrode 1226 before touch is marked as Cm, a mutual-capacitance between the first electrode 1224 and the second electrode 1226 after touch is marked as Cm′, and a mutual-capacitance difference between the first electrode 1224 and the second electrode 1226 before and after touch is ΔC=Cm−Cm′. A value of ΔC/Cm is taken as a reference value for evaluating performance of the touch panel 12. The greater the value of ΔC/Cm, the easier the acquisition of a touch signal by a touch integrated circuit, and the better the performance of the touch panel 12. The distance between the opposing edges of the first section 122a and the second section 122b that are inclined is less and the lengths of the opposing edges thereof are greater, electric field lines between the first electrode 1222 and the second electrode 1224 are densely deployed, more effective electric field lines contribute to variation of the mutual-capacitance, and a mutual-capacitance difference ΔC during touch is increased greatly. Therefore, the value of ΔC/Cm is increased, and the performance of the touch panel 12 is improved.

In summary, according to the present disclosure, the first section 122a and the second section 122b are disposed to incline with respect to the outer edge of the touch panel 12, the first section 122a and the second section 122b form the overlapped area 124, the edge of the overlapped area 124 are inclined with respect to the outer edge of the touch panel 12. With such configurations, by changing the inclination degrees of the first section 122a and the second section 122b, the interaction distance between the opposing edges of the first electrode 1224 and the second electrode 1226 and the interaction angle between the first section 122a and the second section 122b may be increased, such that the performance of the touch panel 12 is improved.

Moreover, the wiring of the touch panel 12 in the overlapped area 124 exerts some impacts on the resistance of the touch panel 12. The overlapped area 124 according to the present disclosure has many variable structures. Therefore, the resistance of the entire touch panel 12 may be adjusted by changing the wiring of the touch panel 12 in the overlapped area 124, and hence the touch performance is adjusted.

The fact that the extending direction of the first section 122a and/or the second section 122b is inclined with respect to the outer edge of the touch panel 12 may be understood as follows: The extending direction of the first section 122a is inclined with respect to the outer edge of the touch panel 12, whereas the extending direction of the second section 122b is not inclined with respect to the outer edge of the touch panel 12; the extending direction of the first section 122a is not inclined with respect to the outer edge of the touch panel 12 whereas the extending direction of the second section 122b is inclined with respect to the outer edge of the touch panel 12; and the extending directions of the first section 122a and the second section 122b are both inclined with respect to the outer edge of the touch panel 12. That is, the extending direction of at least one of the first section 122a and the second section 122b is inclined with respect to the outer edge of the touch panel 12, and at least one edge of the formed overlapped area 124 is inclined with respect to the outer edge of the touch panel 12. The overlapped area 124 includes a plurality of edges, and preferably, all the edges of the overlapped area 124 are inclined with respect to the outer edge of the touch panel 12, to enhance the shadow elimination effect.

The extending direction of the first section 122a may be understood as an extending direction of an edge of the first section 122a. The extending direction of the second section 122b may be understood as an extending direction of an edge of the second section 122b. The fact that the first section 122a is inclined with respect to the outer edge of the touch panel 12 may be understood as follows: At least one edge of the first section 122a is inclined with respect to at least one outer edge of the touch panel 12. The fact that the second section 122b is inclined with respect to the outer edge of the touch panel 12 may be understood as follows: At least one edge of the second section 122b is inclined with respect to at least one outer edge of the touch panel 12. The inclination with respect to each other may be interpreted as that the two edges are not parallel and define an included angle that is not 90 degrees.

The insulating layer 1222 may be made of such materials as glass, polyethylene terephthalate (PET), or polymethyl methacrylate (PMMA). The first electrode 1224 and the second electrode 1226 are fabricated on the insulating layer 1222 by a mask process, wherein the first electrode 1224 and the second electrode 1226 are disposed on different surfaces.

The first electrode 1224 may be a receiving electrode of the touch unit 122, and the second electrode 1226 may be a transmitting electrode of the touch unit 122; or the first electrode 1224 is a transmitting electrode of the touch unit 122, and the second electrode 1226 may be a receiving electrode of the touch unit 122. In the embodiments of the present disclosure, description is made using the case where the first electrode 1224 is a receiving electrode and the second electrode 1226 is a transmitting electrode as an example. The first electrode 1224 and the second electrode 1226 in the embodiments of the present disclosure are only described as examples. In some other embodiments, the first electrode 1224 and the second electrode 1226 may be other electrodes, which are not limited herein.

In some embodiments, when the extending direction of the first section 122a is inclined with respect to the outer edge of the touch panel 12, an included angle defined between the extending direction of the first section 122a and the outer edge of the touch panel 12 is (0°, 90°) or (90°, 180°) or (180°, 270°) or (270°, 360°); and/or when the extending direction of the second section 122b is inclined with respect to the outer edge of the touch panel 12, an included angle defined between the extending direction of the second section 122b and the outer edge of the touch panel 12 is (0°, 90°) or (90°, 180°) or (180°, 270°) or (270°, 360°).

As such, the first section 122a and the second section 122b have more extending directions and angles, and may make combinations to form the overlapped area 124 in more other shapes and forms, such that the touch unit 122 has more structure variations to accommodate more requirements of the touch panel 12. Furthermore, the shadow elimination effect of the touch unit 122 and the touch panel 12 may be further enhanced. The overlapped area 124 formed by the first electrode 1224 and the second electrode 1226 has a wide adjustment range, which facilitates adjustment of the capacitance of the touch unit 122. Further, with such an adjustment range, it is convenient to adjust the wiring of the touch panel 12 in the overlapped area 124 to adjust the resistance of the entire touch panel 12, such that power consumption requirements of the touch screen 10 and the terminal 100 are accommodated. It may be understood that the extending direction of the first section 122a, the extending direction of the second section 122b, and the outer edge of the touch panel 12 are not parallel or perpendicular to each other.

In some embodiments, when the extending direction of the first section 122a is inclined with respect to the outer edge of the touch panel 12, the included angle defined between the extending direction of the first section 122a and the outer edge of the touch panel 12 is [30°, 60°]; and when the extending direction of the second section 122b is inclined with respect to the outer edge of the touch panel 12, the included angle defined between the extending direction of the second section 122b and the outer edge of the touch panel 12 is [30°, 60° ].

The inclination degree of the extending direction of the first section 122a with respect to the outer edge of the touch panel 12 is greater, the inclination degree of the extending direction of the second section 122b with respect to the outer edge of the touch panel 12 is greater, and thus the inclination degree of the edges of the formed overlapped area 124 with respect to the outer edge of the touch panel 12 is greater. In this way, the visibility of the human eyes to the etching textures or grids on the touch panel 12 is effectively reduced.

Preferably, when the extending direction of the first section 122a is inclined with respect to the outer edge of the touch panel 12, the included angle defined between the extending direction of the first section 122a and the outer edge of the touch panel 12 is 30°, 37°, 40°, 41°, 45°, 50°, 57°, or 60°; and when the extending direction of the second section 122b is inclined with respect to the outer edge of the touch panel 12, the included angle defined between the extending direction of the second section 122b and the outer edge of the touch panel 12 is 30°, 37°, 40°, 41°, 45°, 50°, 57°, or 60°.

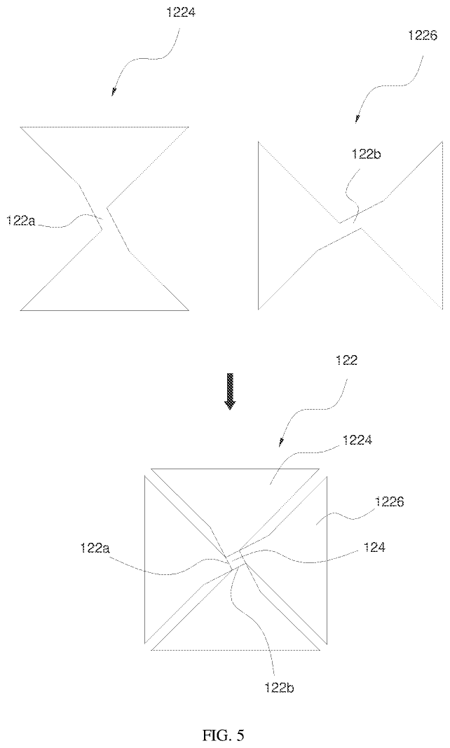

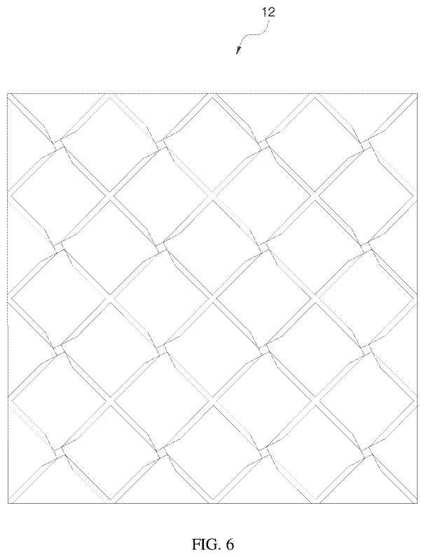

Referring to FIG. 5 and FIG. 12, in some embodiments, the extending direction of the first section 122a is perpendicular or parallel to the extending direction of the second section 122b.

It may be understood that the extending direction of the first section 122a and the extending direction of the second section 122b may be perpendicular to (as illustrated in FIG. 5) or parallel to (as illustrated in FIG. 12) each other. In this way, the overlapped area 124 regular in structure may be formed. For example, an external profile of the overlapped region 124 may be a rectangle, a square, a parallelogram, or the like.

Referring to FIG. 4, in some embodiments, a plurality of touch units 122 may be configured, and the plurality of touch units 122 are arranged in an array.

The array of the plurality of touch units 122 facilitates arrangement, which facilitates formation of the regular touch panel 12. As such, the touch units 122 are compact between each other, and thus space utilization rate of the touch panel 12 is improved and more touch units 122 may be disposed, such that external touch operations are better sensed, and touch sensing is more precise and accurate.

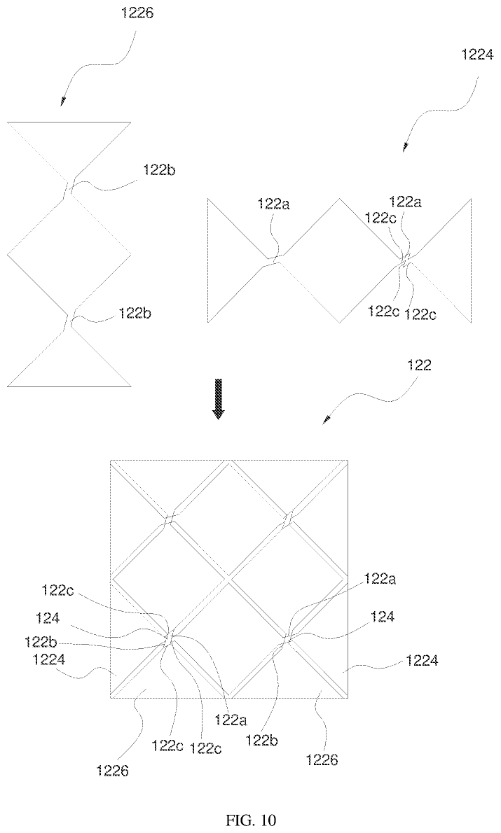

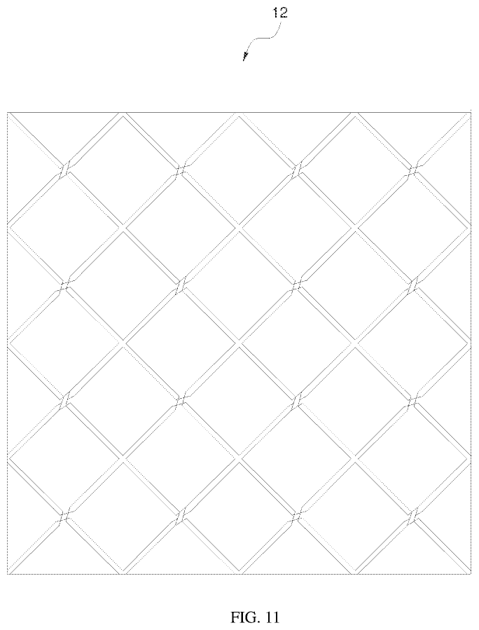

Referring to FIG. 2 and FIG. 10, in some embodiments, the touch units 122 form a plurality of overlapped areas 124, and the touch unit 122 includes a plurality of first sections 122a and a plurality of second sections 122b. The extending direction of at least one of the first sections 122a is inclined with respect to the outer edge of the touch panel 12; and/or the extending direction of at least one of the second sections 122b is inclined with respect to the outer edge of the touch panel 12. The plurality of first sections 122a and the plurality of second sections 122b are crossed and stacked over each other to form a plurality of overlapped areas 124.

The fact that the extending direction of at least one of the first sections 122a is inclined with respect to the outer edge of the touch panel 12 and/or the extending direction of at least one of the second sections 122b is inclined with respect to the outer edge of the touch panel 12 may be understood as follows: The extending direction of at least one of the first sections 122a is inclined with respect to the outer edge of the touch panel 12, and the extending direction of at least one of the second sections 122b is inclined with respect to the outer edge of the touch panel 12; or the extending direction of at least one of the first sections 122a is inclined with respect to the outer edge of the touch panel 12, and the extending direction of at least one of the second sections 122b is inclined or not inclined with respect to the outer edge of the touch panel 12; or the extending direction of at least one of the first sections 122a is inclined or not inclined with respect to the outer edge of the touch panel 12, and the extending direction of at least one of the second sections 122b is inclined with respect to the outer edge of the touch panel 12.

As such, the plurality of first sections 122a and the plurality of second sections 122b may form different overlapped areas 124 that are inclined with respect to the outer edge of the touch panel 12, such that the touch panel 12 having more variations and combinations is formed to accommodate more different requirements of the touch panel 12, and the shadow elimination effect of the touch panel 12 is further improved to enhance the display quality of the touch display screen 10.

In some embodiments, the plurality of first sections 122a have the same or different shapes; and/or the plurality of second sections 122b have the same or different shapes.

Specifically, the fact that the plurality of first sections 122a have the same or different shapes and/or the plurality of second sections 122b have the same or different shapes may be understood as follows: The plurality of first sections 122a have the same shape, and the plurality of second sections 122b have the same shape; or the plurality of first sections 122a have different shapes, and the plurality of second sections 122b have the same shape; or the plurality of first sections 122a have different shapes, and the plurality of second sections 122b have different shapes; or the plurality of first sections 122a have the same section, and the plurality of second sections 122b have different shapes.

As such, with the same shape or different shapes, the plurality of first sections 122a and the plurality of second sections 122b may form more combinations, and may form the overlapped area 124 having more shapes, such that the touch units 122 having multiple internal shapes are formed to accommodate more different requirements of the touch panel 12.

In some embodiments, the first electrode 1224 and/or the second electrode 1226 may be made of a metal conductive material. The metal conductive material includes at least one of indium tin oxide (ITO), nano-silver (nano-Ag), titanium-aluminum-titanium, or molybdenum-aluminum-molybdenum.

As such, the first electrode 1224 and the second electrode 1226 may be made of different optional materials and a combination of these materials, such that a plurality of types of touch panels 12 may be formed to accommodate different requirements.

Specifically, the indium tin oxide has good conductivity and transparency, and is capable of receiving electronic radiations, ultraviolet rays, infrared rays and the like hazardous to human bodies. The indium tin oxide may be sprayed on glass, plastics, and electronic display screen as a transparent conductive thin film. The nano-silver has good conductivity, and may be coated on the substrate to form a conductive thin film. The titanium-aluminum-titanium and the molybdenum-aluminum-molybdenum materials may be fabricated into a metal grid shape by a metal-mesh technique. For example, these materials may be fabricated into a single-layer metal grid which is applied to the touch unit 122, or fabricated into multiple metal grids which are laminated together and applied to the touch unit 122. By the metal-mesh technique, the conductive metal material may be formed on different insulating substrates, for example, a glass substrate, a PET substrate, a PMMA substrate, or the like. The metal grid fabricated by the metal-mesh technique has a small resistance, and has a small wiring resistance in the touch display screen 10. In this way, the size of the touch display screen 10 is improved, and power consumption is reduced.

Preferably, when the first electrode 1224 and the second electrode 1226 are made of the transparent conductive material, reflections of ambient light and internal light of the touch display screen 10 by the touch unit 122 may be further eliminated, such that the shadow elimination effect is enhanced.

In one embodiment, when the first electrode 1224 and the second electrode 1226 are both made of the indium tin oxide, an indium tin oxide film layer may be formed by magnetron sputtering, chemical vapor deposition or sol-gel process, and two opposing sides of the first electrode 1224 and the second electrode 1226 on the insulating layer 1222 are formed by the mask process.

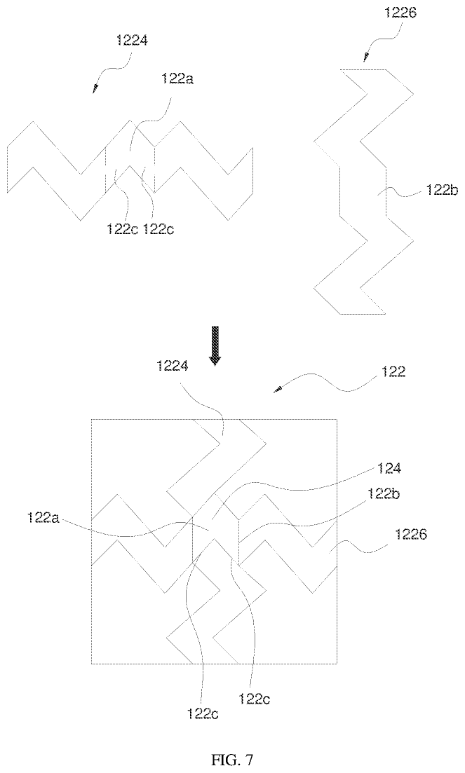

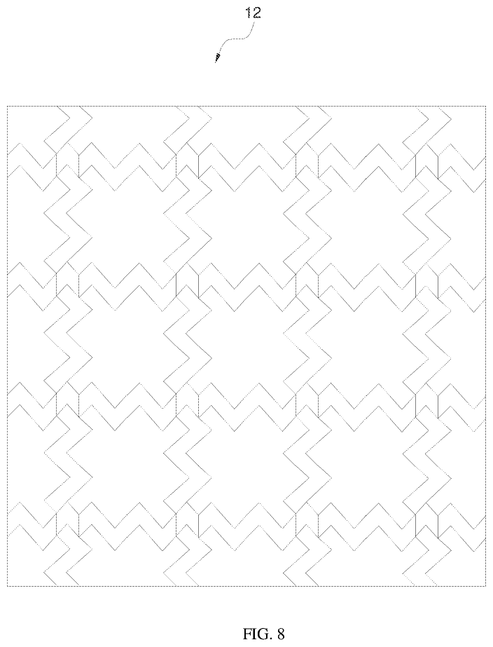

Referring to FIG. 5 and FIG. 6, in some embodiments, the touch unit 122 includes a single first section 122a and a single second section 122b, wherein the extending direction of the first section 122a is perpendicular to the extending direction of the second section 122b.

Specifically, the extending direction of the first section 122a is perpendicular to the extending direction of the second section 122b, and the distance and included angle between the first electrode 1224 and the second electrode 1226 are easily adjusted. In this way, the fundamental mutual-capacitance between the first electrode 1224 and the second electrode 1226 and the mutual-capacitance after touch are conveniently adjusted to adjust the capacitance of the touch unit 122, such that touch sensing of the touch panel 12 is more quickly responsive and accurate. Moreover, the overlapped area 124 is approximately in a regular square shape.

Further referring to FIG. 2, in some embodiments, the outer edge of the touch panel 12 includes a first edge 126 extending along a first direction and a second edge 128 extending along a second direction. The first edge 126 is perpendicular to the second edge 128. An included angle defined between the first section 122a and the first edge 126 is 45°, and an included angle defined between the second section 122b and the second edge 128 is 45°.

Since the included angle defined between the first section 122a and the first edge 126 is 45°, the included angle defined between the second section 122b and the second edge 128 is 45°, and the first edge 126 is perpendicular to the second edge 128, the first section 122a and the second section 122b may be perpendicular to each other to form the overlapped area 124 that is regular and compact. In this way, the touch units 122, the touch panel 12, and the touch screen 10 are further formed to be regular and compact, and the shadow elimination effect may be further enhanced.

The display panel 14 may be in a rectangular shape, a round-angled rectangular shape, or the like to accommodate use habits of the user, which also facilitates fabrication of the display panel 14. Nevertheless, in other embodiments, the display panel 14 is not limited to the rectangular shape, the round-angled rectangular shape or the like, which is not limited herein.

Referring to FIG. 7, in some embodiments, the touch unit 122 includes a single first section 122a and a single second section 122b, wherein the first section 122a includes a plurality of first sub-sections 122c extending along different directions.

Since the first section 122a includes a plurality of first sub-sections 122c extending along different directions, the first section 122a may be combined with the single second section 122b to form the overlapped area 124 with more variable structures, such that the touch units 122 with multiple structures are formed. In the embodiment as illustrated in FIG. 7, the number of first sub-sections 122c is two, the first section 122a and the second section 122b have some combination variations, and have a simple structure. In more other embodiments, the number of first sub-sections 122c may be three, four, five, or more, to form more structure combinations with the second section 122b. In this way, the overlapped area 124 has more structure variations, and the shadow elimination effect may be further enhanced.

In another embodiment, the touch unit 122 includes a single first section 122a and a single second section 122b, wherein the second section 122b includes a plurality of second sub-sections (not illustrated in FIG. 7) extending along different directions.

Referring to FIG. 2 and FIG. 7, in some embodiments, the outer edge of the touch panel 12 includes a first edge 126 extending along a first direction and a second edge 128 extending along a second direction, wherein the extending directions of the plurality of first sub-sections 122c are inclined with respect to the second edge 128.

When the extending directions of the plurality of first sub-sections 122c are inclined with respect to the second edge 128, the area of the first section 122a is increased such that the area of the first electrode 1224 is increased. In this way, the light refracted or reflected from the edge of the first electrode 1224 is dispersed and absorbed, and thus the shadow elimination effect is further enhanced.

Still referring to FIG. 2 and FIG. 7, in some embodiments, the first edge 126 is perpendicular to the second edge 128, and the extending direction of the second section 122b is parallel to the first edge 126.

The extending direction of the second section 122b is parallel to the first edge 126, and when the second section 122b cooperates with the first sub-section 122c whose extending direction is inclined with respect to the second edge 128, the shadow elimination effect of the touch unit 122 is achieved, and the display quality of the touch display screen 10 is ensured. Nevertheless, in more other embodiments, the extending direction of the second section 122b is not parallel to the first edge 126, which is not limited herein.

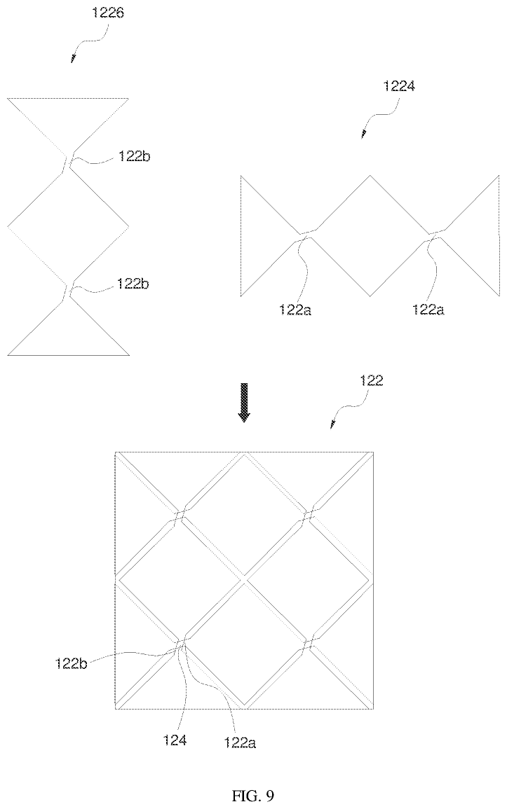

Referring FIG. 9, in some embodiments, the first electrode 1224 includes a plurality of first sections 122a, wherein the extending directions of the plurality of first sections 122a are parallel to each other; and the second electrode 1226 includes a plurality of second sections 122b, wherein the extending directions of the plurality of second sections 122b are parallel to each other.

When the extending directions of the plurality of first sections 122a are parallel to each other and the extending directions of the plurality of second sections 122b are parallel to each other, an overlapped area 124 with relatively regular edges is formed, for example, a diamond shape, a parallelogram shape, or the like shape. In this way, it is convenient to fabricate the first electrode 1224 and the second electrode 1226.

In the embodiment as illustrated in FIG. 9, the number of first sections 122a and the number of second sections 122b are both two, such that the first section 122a and the second section 122b are easily combined and arranged, and have some structure variations. In more other embodiments, the number of first sections 122a and the number of second sections 122b may be more than two, for example, three, four, five, or more, to further improve combinations of the first electrode 1224 and the second electrode 1226. In this way, the shadow elimination effect of the touch panel 12 is further enhanced.

Referring to FIG. 2, in some embodiments, the outer edge of the touch panel 12 includes a first edge 126 extending along a first direction and a second edge 128 extending along a second direction, wherein the extending directions of the plurality of first sections 122a are inclined with respect to the first edge 126 and/or the extending directions the plurality of second sections 122b are inclined with respect to the second edge 128.

When the extending directions of the plurality of first sections 122a are inclined with respect to the first edge 126 and the extending directions of the plurality of second sections 122b are inclined with respect to the second edge 128, the shadow elimination effect of the touch unit 122 and the touch panel 12 may be further enhanced. In this way, the resistance of the touch panel 12 may be adjusted by adjusting the wiring of the touch panel 12 in the overlapped area 124, and thus power consumption requirements of the display screen 10 and the terminal 100 are accommodated.

The fact that the extending directions of the plurality of first sections 122a are inclined with respect to the first edge 126 and/or the extending directions of the plurality of second sections 122b are inclined with respect to the second edge 128 may be understood as follows: The extending directions of the plurality of first sections 122a are inclined with respect to the first edge 126, and the extending directions of the plurality of second sections 122b are inclined with respect to the second edge 128; or the extending directions of the plurality of first sections 122a are inclined with respect to the first edge 126, and the extending direction of at least one of the plurality of second sections 122b is not inclined with respect to the second edge 128; or the extending direction of at least one of the plurality of first sections 122a is not inclined with respect to the first edge 126, and the extending directions of the plurality of second sections 122b are inclined with respect to the second edge 128.

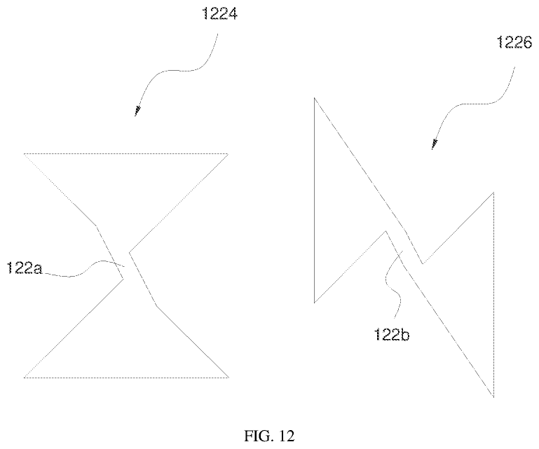

Referring FIG. 10 and FIG. 11, in some embodiments, the first electrode 1224 includes a plurality of first sections 122a, wherein at least two of the plurality of first sections 122a have different shapes; and the second electrode 1226 includes a plurality of second sections 122b, wherein the extending directions of the plurality of second sections 122b are parallel to each other.

The extending directions of the plurality of second sections 122b are parallel to each other, such that the structure of the second electrode 1226 is relative regular, which facilitates fabrication of the second electrode 1226. A plurality of first sections 122a having different shapes may be combined with a plurality of second electrodes 1226 to form a plurality of overlapped regions 124 having different shapes. In this way, shape variations of the touch unit 122 may be improved to accommodate more requirements and improve adaptation of the touch display screen 10.

Referring to FIG. 2, in some embodiments, the outer edge of the touch panel 12 includes a first edge 126 extending along a first direction and a second edge 128 extending along a second direction, wherein the extending directions of the plurality of second sections 122b are inclined with respect to the first edge 126, the extending direction of at least one of the plurality of first sections 122a is inclined with respect to the second edge 128, and at least one of the plurality of first sections 122a includes a plurality of first sub-sections 122c extending along different directions.

As such, the shadow elimination effect of the touch panel 12 is further enhanced, and the display quality of the touch display screen 10 is ensured. The first section 122a and the second 122b have more structure combinations and variations, and thus the overlapped areas 124 having more shapes may be formed. In this way, the capacitance of the touch unit 122 is conveniently adjusted, the resistance of the touch panel 12 is conveniently adjusted by adjusting the wiring of the touch panel 12 in the overlapped area 124, and thus power consumption requirements of the display screen 10 and the terminal 100 are accommodated.

The first direction may be a horizontal direction, and the second direction may be a vertical direction. The first direction is perpendicular to the second direction. In this way, the structure of the display panel 14 is more regular, which facilitates fabrication.

Still referring to FIG. 10, in some embodiments, at least one first section 122a includes three first sub-sections 122c extending along different directions, wherein the three first sub-sections 122c are connected in a Z shape. The extending direction of one of the first sub-sections 122c is the same as the extending direction of the second section 122b.

The three first sub-sections 122c are connected to form a Z-shaped first section 122a, and such a Z-shaped configuration allows more structure combinations for the first section 122a and the second section 122b to form the overlapped areas 124 having more different shapes. The overlapped area 124 may be in a regular or irregular shape such as a square, a rectangle, a diamond, or a parallelogram, which increases shape variations of the touch unit 122. In this way, the touch display screen 10 may adapt to more requirements, and the shadow elimination effect of the touch unit 122 and the touch panel 12 may be further enhanced. The overlapped areas 124 formed by combinations of different first sub-section 122c facilitate adjustment of the capacitance of the touch unit. In this way, the capacitance of the touch unit 122 is conveniently adjusted, the resistance of the touch panel 12 is conveniently adjusted by adjusting the wiring of the touch panel 12 in the overlapped area 124, and thus power consumption requirements of the display screen 10 and the terminal 100 are accommodated. Nevertheless, the first section 122a formed by the three first sub-sections 122c is not limited to the above-described Z shape, which may be defined to any other shapes in the specific embodiments.

In one embodiment, the plurality of first sections 122a have the same shape, and the plurality of second sections 122b have different shapes.

Referring to FIG. 2, the display panel 10 according to the embodiments of the present disclosure includes a display panel 14 and a touch panel 12, wherein the touch panel 12 is disposed under or over the display panel 14, and bonded to the display panel 14.

The touch panel 12 may be bonded to the display panel 14 via a medium, such as an optical adhesive. The optical adhesive only adheres the touch panel 12 and the display panel 14, but also emits light through the touch panel 12. The touch panel 12 may be made of a material having a transmittance greater than 90% against visible light, such that the touch display screen 10 achieves a better content exhibition effect. The touch panel 12 is capable of receiving a touch action of the user on the touch display screen 10 and generating an input signal. The input signal may be further transmitted to a processor (not illustrated in FIG. 2) for data processing, and hence a specific position of touch of the user on the touch display screen 10 is acquired.

In the embodiment as illustrated in FIG. 2, the touch panel includes an active area (AA), the display panel includes a view area (VA). Edges of the active area and the view area are parallel to each other. Therefore, at least one edge of the overlapped area 124 is inclined with respect to an edge of the view area. The display panel 14 includes a third edge 142 and a fourth edge 144 that are perpendicular to each other, wherein the third edge 142 of the display panel 14 is parallel to the first edge 126 of the touch panel 12, and the fourth edge 144 is parallel to the second edge 128.

In other embodiments, the third edge 142 and the fourth edge 144 of the display panel 14 and the first edge 126 and the second edge 128 of the touch panel 12 are not all parallel to each other, or none of these edges are parallel to each other.

In some embodiments, the display panel 14 includes an organic light-emitting diode (OLED) display screen or a liquid crystal display (LCD).

Specifically, the OLED display screen has advantages such as self-luminescence, large view angle, high contrast, low power consumption, short response time, the ability of light emitting in a full color range, simple fabrication, and the like. The LCD has advantages such as low voltage, low power consumption, compact size, no glare, no stimulus to human eyes, large amount of displayed information, easy colorization, no electromagnetic radiation, long service life, and the like. The OLED and LCD are widely applied in the display fields, which help the touch panel 12 and the touch display screen 10 accommodate different requirements.

In some embodiments, the touch display screen 10 may be encapsulated in an out-cell touch screen encapsulation and a thin film encapsulation.

Specifically, the out-cell configuration of the touch display screen 10 includes a G/G structure, a G/F/F structure, a GF or GTM structure, an OGS structure, and the like, wherein the structure formed by the carrier provided with ITO such as glass, a substrate thin film and the like is the touch panel 12. By the thin film encapsulation (TFE), the touch panel 12 may be directly disposed on an encapsulation layer of the touch display panel 10 (touch on TFE) to form an integral structure, so as to improve quality of the touch display screen 10. The structure fabricated by the TFE technique is formed by lamination of inorganic and organic materials. The encapsulated touch display screen 10 has a higher integrity, which facilitates isolation of external interference such as moistures and impurities. In this way, quality of the touch panel 12 is improved, and service life of the touch panel 12 is ensured.

Referring to FIG. 1, the terminal 100 according to the embodiments of the present disclosure includes a housing 20 and a touch display screen 10. The touch display screen 10 is received in the housing 20.

Specifically, an accommodation chamber (not illustrated in FIG. 1) configured to receive the touch display screen 10 may be formed in the housing 20. The housing 20 may be provided with a bearing structure configured to fix the touch display screen 10. The touch display screen 10 is further adhered to an inner wall or a corresponding structure of the housing 20 via an optical adhesive, such that the touch display screen 10 is fixed in the housing 20. The housing 20 may be made of a material such as glass, a metal, ceramic, sapphire, or plastic. These materials all have a high strength, and are easily available and fabricable.

In the description of the present specification, reference terms such as “an embodiment,” “some embodiments,” “examples,” “specific examples,” “some examples,” or the like are intended to refer to that the specific features, structures, materials, or characteristics which are described in combination with the embodiments or examples are included in at least one embodiment or example of the present disclosure. In this specification, schematic expressions of the above terms do not necessarily indicate the same embodiments or examples. In addition, the described specific features, structures, materials, or characteristics may be combined in any one or multiple embodiments or examples in a suitable way.

Although the embodiments of the present disclosure are described in detail above, persons or ordinary skill in the art may understand that without departing from the principle and intention of the present disclosure, various variations, modifications, and replacements may be made to these embodiments, and the scope of the present disclosure is defined by the appended claims and their equivalents.

1. A touch panel, comprising:
a touch unit, wherein the touch unit comprises:
an insulating layer;
a first electrode disposed on one side of the insulating layer; and
a second electrode disposed on the other side of the insulating layer, orthographic projections of the first electrode and the second electrode on the insulating layer forming an overlapped area, the first electrode comprising a first section corresponding to the overlapped area, the second electrode comprising a second section corresponding to the overlapped area, at least one of an extending direction of the first section and an extending direction of the second section being inclined with respect to an outer edge of the touch panel.

2. The touch panel according to claim 1, wherein when the extending direction of the first section is inclined with respect to the outer edge of the touch panel, an included angle defined between the extending direction of the first section and the outer edge of the touch panel is (0°, 90°) or (90°, 180°) or (180°, 270°) or (270°, 360°); and
when the extending direction of the second section is inclined with respect to the outer edge of the touch panel, an included angle defined between the extending direction of the second section and the outer edge of the touch panel is (0°, 90°) or (90°, 180°) or (180°, 270°) or (270°, 360°).

3. The touch panel according to claim 1, wherein when the extending direction of the first section is inclined with respect to the outer edge of the touch panel, an included angle defined between the extending direction of the first section and the outer edge of the touch panel is [30°, 60°]; and
when the extending direction of the second section is inclined with respect to the outer edge of the touch panel, an included angle defined between the extending direction of the second section and the outer edge of the touch panel is [30°, 60°].

4. The touch panel according to claim 1, wherein at least one edge of the overlapped area is inclined with respect to the outer edge of the touch panel.

5. The touch panel according to claim 1, wherein the extending direction of the first section is perpendicular to or parallel to the extending direction of the second section.

6. The touch panel according to claim 1, wherein a plurality of touch units is disposed, and the plurality of the touch units are arranged in an array.

7. The touch panel according to claim 1, wherein the touch unit comprises a plurality of overlapped areas; the touch unit comprising a plurality of the first sections and a plurality of the second sections, the extending direction of at least one of the first sections being inclined with respect to the outer edge of the touch panel, and/or the extending direction of at least one of the second sections being inclined with respect to the outer edge of the touch panel.

8. The touch panel according to claim 7, wherein shapes of the plurality of the first sections are the same or different, and shapes of the plurality of second sections are the same or different.

9. The touch panel according to claim 1, wherein the touch unit comprises a single first section and a single second section, and the extending direction of the first section is perpendicular to the extending direction of the second section.

10. The touch panel according to claim 9, wherein the outer edge of the touch panel comprises a first edge extending along a first direction and a second edge extending along a second direction, the first edge being perpendicular to the second edge, an included angle defined between the first section and the first edge being 45°, an included angle defined between the second section and the second edge being 45°.

11. The touch panel according to claim 1, wherein the touch unit comprises a single first section and a single second section, and the first section comprises a plurality of first sub-sections extending along different directions.

12. The touch panel according to claim 11, wherein the outer edge of the touch panel comprises a first edge extending along a first direction and a second edge extending along a second direction, and extending directions of the plurality of first sub-sections are inclined with respect to the second edge.

13. The touch panel according to claim 12, wherein the first edge is perpendicular to the second edge, and the extending direction of the second section is parallel to the first edge.

14. The touch panel according to claim 1, wherein the first electrode comprises a plurality of the first sections, and extending directions of the plurality of the first sections are parallel to each other; the second electrode comprising a plurality of second sections, extending directions of the plurality of second sections being parallel to each other.

15. The touch panel according to claim 14, wherein the outer edge of the touch panel comprises a first edge extending along a first direction and a second edge extending along a second direction, and extending directions of the plurality of the first sections are inclined with respect to the first edge, and/or
extending direction of the plurality of the second sections are inclined with respect to the second edge.

16. The touch panel according to claim 1, wherein the first electrode comprises a plurality of the first sections, and shapes of at least two of the first sections are different;
the second electrode comprising a plurality of the second sections, extending directions of the plurality of the second sections being parallel to each other.

17. The touch panel according to claim 16, wherein the outer edge of the touch panel comprises a first edge extending along a first direction and a second edge extending along a second direction, and extending directions of the plurality of the second sections are inclined with respect to the first edge; extending direction of at least one of the plurality of the first sections being inclined with respect to the second edge, at least one of the plurality of the first sections comprising a plurality of sub-sections extending along different directions.

18. The touch panel according to claim 17, wherein at least one of the plurality of the first sections comprises three first sub-sections extending along different directions, the three first sub-sections being arranged in a Z shape, an extending direction of at least one of the first sub-sections being the same as the extending direction of the second section.

19. A touch display screen, comprising:
a display panel; and
a touch panel, wherein the touch panel and the display panel are laminated;
the touch panel, comprising:
a touch unit, wherein the touch unit comprises:
an insulating layer;
a first electrode disposed on one side of the insulating layer; and
a second electrode disposed on the other side of the insulating layer, orthographic projections of the first electrode and the second electrode on the insulating layer forming an overlapped area, the first electrode comprising a first section corresponding to the overlapped area, the second electrode comprising a second section corresponding to the overlapped area, at least one of an extending direction of the first section and an extending direction of the second section being inclined with respect to an outer edge of the touch panel.

20. A terminal, comprising:
a housing; and
a touch display screen, wherein the touch display screen is arranged in the housing;
the touch display screen, comprising:
a display panel; and
a touch panel, wherein the touch panel and the display panel are laminated;
the touch panel, comprising:
a touch unit, wherein the touch unit comprises:
an insulating layer;
a first electrode disposed on one side of the insulating layer; and
a second electrode disposed on the other side of the insulating layer, orthographic projections of the first electrode and the second electrode on the insulating layer forming an overlapped area, the first electrode comprising a first section corresponding to the overlapped area, the second electrode comprising a second section corresponding to the overlapped area, at least one of an extending direction of the first section and an extending direction of the second section being inclined with respect to an outer edge of the touch panel.
